(19) United States
(12) Patent Application Publication
(10) Pub. No.: US 2022/0189075 A1
(43) Pub. Date: Jun. 16, 2022

(54) Augmented Reality Display Of Commercial And Residential Features During In-Person Real Estate Showings/Open Houses and Vacation Rental Stays

(71) Applicant: Fire Solutions Group, Seven Valleys, PA (US)

(72) Inventors: James Andy Lynch, Seven Valleys, PA (US); Michael Ferreira, Parkton, MD (US)

(73) Assignee: Fire Solutions Group, Seven Valleys, PA (US)

(21) Appl. No.: 17/547,931

(22) Filed: Dec. 10, 2021

Related U.S. Application Data
(60) Provisional application No. 63/124,389, filed on Dec. 11, 2020.

(51) Int. Cl. G06T 11/00; G06F 3/04883; G06Q 50/16

(52) U.S. Cl. CPC G06T 11/00; G06T 2200/24; G06Q 50/16; G06F 3/04883

(57) ABSTRACT

A system and method of preparing an augmented reality (AR) composite view, configured to create, edit, store, and display information, highlight property features, provide visualizations, and display location information during in-person real estate showings/open houses and during vacation rental property stays. The system includes an AR Editor such that a user may edit and input AR element information into an electronically stored database and a AR Portal for a user to upload and assign linked meta information corresponding to the AR elements in the stored database The system also includes an AR Viewer, where the relevant information from the electronically stored database is determined based on each user's location and view direction. The AR Viewer displays a composite image incorporating AR elements over the real-time field of view of the user, indicating the availability of useful information, including property features. Selecting an AR element (icon, 3D shape, or 3D avatar in turn displays the text information, linked documents, pictures, videos, 3D avatar videos, or audio files as linked to that object in the database.

### FIELD OF THE INVENTION

The invention relates to a method and system of using hardware and software, and more particularly, to a method and system providing geospatial-referenced information pertaining to commercial and residential property features. Further, the invention relates to an augmented reality (AR) system that will provide pertinent information and visuals concerning real estate features and information, as may usefully be provided to building owners and managers, real estate agents, potential buyers, or property renters. The present invention relates to the creation and display of augmented reality to assist in real estate sales or rental stays. The invention includes the creation of augmented reality digital images for display from a baseline 3D scan of a real estate property for sale or rent, storage of related meta information, and display of information on mobile devices using augmented reality. The invention also includes an end-to-end system for a user to create the AR elements via an AR Editor, link the elements to stored metadata information via an AR Web Portal, and provide to potential buyers and renters an AR Viewer for viewing the AR elements and linked information.

### BACKGROUND

Real estate sales and lease/rental markets employed 1.3 million licensed realtors according to 2018 statistics. Approximately 70% of realtors specialize in residential real estate and are involved in most of the 5-6 million single family home sales occurring in the U.S. per year. The remaining 30% of realtors specialize in the commercial real estate sales and lease/rental markets involving the approximately 4 billion square feet of office space in the U.S.

Real estate agents work to present the properties in a desirable light to increase demand and the property's sale price. Buildings and homes contain features that are desirable to highlight during the selling process. These features include architectural elements, recent capital improvements, energy saving features, appliances and utilities, and furnishings that may convey with the sale. Information pertaining to the neighborhood, community, local schools may also be provided.

Critical information pertaining to a property for sale is often obtained from one of the approximately 600 multiple listing services (MLS) that aggregate real estate data. The listing data stored in a MLS database is typically the proprietary information of the broker who has obtained a listing agreement with a property's seller.

In addition to using MLS data, real estate agents will create websites, sell sheets, and promote open houses to convey information on a property to attract potential buyers. Real estate agents work to present the properties in a desirable light to increase demand and the sale price.

Real estate agents sometimes utilize 3D cameras to scan a property in order to allow tours of the home to be conducted virtually, often via a realtor website. The scans enable the buyer to virtually walk through a home with access to 360° views from many locations within the property. Statistics show that 73% of homeowners report that they are more likely to list with a Realtor who uses video to sell property.

Real estate agents sometimes stage the property to positively present the property and assist buyers in visualizing the space. For unoccupied properties, the staging process may require leasing furniture to stage each room. This cost significant rental fees and the selection of furnishings may only appeal to the style of a limited number of buyers.

Generic real estate information can seem impersonal or may not address customer specific desires. Due to the large amount of information associated with a property many times information significant to the buyer is left out, categorized in a confusing or misleading way, poorly presented, or have little spatial context.

The presentation of information in a way that is easy to navigate, visualize, and does not require the personal interaction of the agent with every potential buyer is advantageous.

Many buyers want personalized information, features, design, or style that they are looking for.

Many manufactures of items such as furniture, paint and flooring are creating augmented reality application so buyers can visualize the piece of furniture, paint color, or flooring within a home or office space.

There are 9 million second homes in the U.S., and 25 percent of those are rented through property management companies. Each of those companies has on average 100 units, so the total number of the vacation rental companies in 2018 in the United States is approximately 23,000.

Property managers currently use various methods to communicate pertinent information to their renters, including printed and posted information, email and text correspondence.

Property managers field numerous maintenance and information calls from their renters. Significant cost savings and efficiency can be generated by minimizing the number of “nuisance” calls asking for equipment operation instructions, and locations of in-home equipment and nearby amenities.

Significant value can be created for rental property owners by providing a means to efficiently communicate equipment operational information and maintenance instructions that enable quick action by the renter that can reduce the extent of property damage. An example would be identifying the location of water shut-off valves a renter can quickly access in the event of a water leak.

What is needed is a system and method that is able to catalog relevant information regarding the property for sale or rent that can be readily edited and updated, so that accurate and timely information may be provided to one or more potential buyers or renters. The system should be able to provide relevant information regarding building features, appliances, room dimensions, seasonal images, informational videos, equipment, and documents in a manner that can be quickly understood, preferably including graphic identification of the locations of relevant features, using augmented reality techniques, wherein the icons and information pertaining to the property, its features and equipment can be effectively conveyed to the end user in a reliable and fast manner.

### SUMMARY OF THE INVENTION

A system and method for using augmented reality (AR) techniques if provided and allows a user to prepare a database of features, information, and locations that can be stored and accessed electronically and displayed for the user on a screen combining the real world view with computer-generated images and information.

An object of the invention is to provide an augmented reality system comprising of (1) an augmented reality editor, (2) a database for the storage of information, (3) a web-portal/database editor and (4) an augmented reality viewer. These components may exist separately or combinations thereof integrated together into single components. The augmented reality editor may be configured to allow entry and editing of volumes, icons, and information for access by the augmented reality viewer. The augmented reality viewer may generate and display augmented reality composite images and linked information. The database will store information from the editor for display in the viewer. Editing of the database will occur from the web-portal/database editor.

The augmented reality editor may include an editor display/input device, electronic memory storage, a computer accessible database containing volume information that identifies property features and information stored in memory, and a computational device and editing software, which may provide an editor interface that is configured to allow selective modifications and entries of related information.

The augmented reality viewer may include a viewer display device, a user interface, a camera, a computing device and viewing software. The viewer display device may be in the form of a cellphone, tablet computer, wearable glasses/headset, or other device enabling display of augmented reality information. The viewing software may be configured to electronically access a computer accessible database and create a composite image for viewing on a display. The composite image displayed may include text, volumetric shapes, icons, graphics, 3D avatars, or other information overlaid upon an image.

In an exemplary embodiment of the augmented reality system, the image upon which augmented reality information is overlaid may be one of: perspective view received from a camera, 2D plan view, or a 3-dimensional virtual representation of a location.

In another exemplary embodiment, the augmented reality system may utilize an image as a perspective view received from a camera, and the camera is one of: a body mounted camera, a drone mounted camera, a helmet mounted camera, display capable glasses or goggles, a hand held camera, a tablet camera, and a cell phone camera.

In another exemplary embodiment, the augmented reality system may provide a composite image included of an image received from the camera, and the overlaid volume information provides an indication of the nature of the features of links to informational documents, images, videos, or audio files stored in a remote storage location.

In another exemplary embodiment, the augmented reality system may be provided with a viewer display that is a touch screen where user input is provided using a finger or stylus, or wearable glasses/headset configured to recognize user gestures as inputs. Furthermore, the input and gestures may be utilized within the system to allow navigation by the user through the user interface.

In another exemplary embodiment of the augmented reality system, the composite image provides a location icon in a fixed location on the viewer display when the camera is located within a pre-determined range of a volume location.

Furthermore, the augmented reality system may provide a composite image that displays an icon representative of all occurrences of the volume information that fall within the composite image. The icon may graphically represent the nature of the volume to the user.

In another exemplary embodiment of the augmented reality system, the icon displayed on the composite image may vary in a property proportional with the distance from the camera. In an exemplary embodiment, the property that is displayed proportionally with the distance from the camera is selected from the group of size, opacity, and combinations thereof.

In another exemplary embodiment, the method of using an augmented reality system is taught, where the augmented reality system is configured to provide a composite augmented reality image comprising volume information and an image, and the method may include the steps of: (1) providing an augmented reality editor and an augmented reality viewer; (2) providing an electronically accessible database containing volume information, identifying features, and information stored in an electronic memory; (3) providing an image representative of a user perspective; (4) determining volume information from the electronically accessible database correspondingly located within the image; (5) overlaying an icon representative of each volume information onto the image to provide a composite augmented reality image; and (6) providing the composite augmented reality image on a user display.

### BRIEF DESCRIPTION OF THE DRAWINGS

Exemplary embodiments of the present invention are illustrated as an example and are not limited by the figures of the accompanying drawings, in which like references may indicate similar elements and in which;

FIG. 1 is a schematic depiction of an AR Viewer on a tablet computer device displaying AR objects (informational icon and text description) superimposed over the real time background image accessed via the device camera according to the invention;

FIG. 2 is a flow diagram showing the components of an AR system according to the invention;

FIG. 3 is a schematic diagram showing communication paths from the data storage to multiple AR Viewers according to the invention;

FIG. 4 provides schematic diagrams of exemplary icons for use with the four primary data types (information, pictures, audio files, video files, and 3D avatar files) according to the invention. Other icon types may be generated for other AR element types, as needed;

FIG. 5 is another schematic depiction of the AR Viewer on a tablet computer device according to the invention displaying a basic information view consisting of the information icon with an accompanying text box;

FIG. 6 is another schematic depiction of the AR Viewer on a tablet computer device according to the invention displaying descriptive text information field linked to the information icon referencing a defined 3D shape highlighting the point of interest;

FIG. 7 is another schematic depiction of the AR Viewer on a tablet computer device according to the invention displaying picture icon and on-screen picture thumbnails that display after selecting the picture icon;

FIG. 8 is another schematic depiction of the AR Viewer on a tablet computer device according to the invention displaying a 3D axis that shows room dimensions in x,y,z directions toggled on and off via one of the fixed on-screen buttons;

FIG. 9 is another schematic depiction of the AR Viewer on a tablet computer device according to the invention displaying a 3D floor plan showing in a pop-up window accessed via one of the fixed on-screen buttons;

FIG. 10 is another schematic depiction of the AR Viewer on a tablet computer device according to the invention displaying an audio button that links to the text shown, broadcast over the viewer's audio speakers;

FIG. 11 is another schematic depiction of the AR Viewer on a tablet computer device according to the invention displaying a linked video file after selecting the video icon displayed on screen;

FIG. 12 is another schematic depiction of the AR Viewer on a tablet computer device according to the invention displaying a 3D avatar video after selecting the avatar video icon displayed on screen;

FIG. 13 is another schematic depiction of the AR Viewer on a tablet computer device according to the invention displaying tiled information not linked to any specific spatial element within the space but instead being displayed as an AR element at a fixed distance from the viewer;

FIG. 14 is another schematic depiction of the AR Viewer on a tablet computer device according to the invention displaying exterior information available via the AR Viewer;

FIG. 15 is another schematic depiction of the AR Editor software configured on a desktop computer according to the invention, used to input AR elements into a 3D representation of a space; and

FIG. 16 is another schematic depiction of the AR Editor software configured on a desktop computer according to the invention displaying the moving axis and sizing axis at it appears on screen to move and size objects in the x, y, and z directions.

### DETAILED DESCRIPTION OF THE EMBODIMENTS

The terminology used herein is for the purpose of describing particular embodiments only and is not intended to be limited of the invention. As used herein, the term “and/or” includes any and all combination of the one or more of the associated listed items. As used herein, the singular forms “a”, “an”, and “the” are intended to include the plural forms as well as the singular forms, unless the context clearly indicates otherwise. It will be further understood the terms “includes” and/or “comprising”, when used in this specification, specify the presence of stated features, steps, operations, elements, and/or components, but not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The present disclosure is to be considered as an exemplification of the invention and is not intended to limit the invention to the specific embodiments illustrated by the figures or description provided.

The present invention will now be described by referencing the appended figures representing exemplary embodiments.

With reference to the figures herein, various aspects of the AR system according to the invention, with particular emphasis on the viewer, and the method of use of the AR Viewer will be described.

### Overall System Architecture

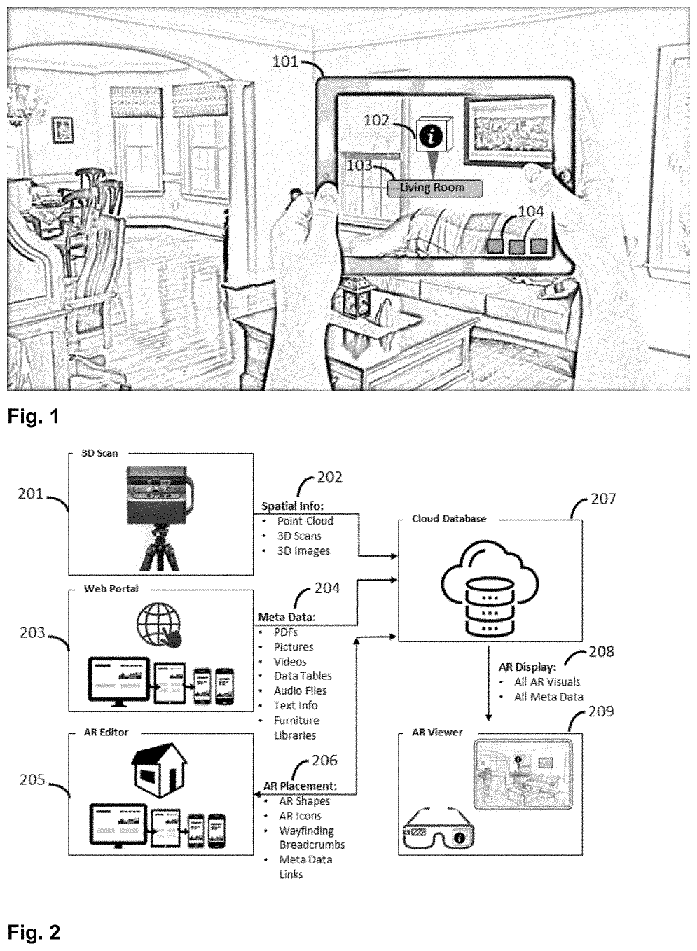

With respect to FIG. 1, an exemplary embodiment of an augmented reality display system according to the invention is shown. Augmented reality (AR) technology displays virtual 2D or 3D elements in the real-time field of view of the user, as shown in various display devices (in the form of a cellphone, tablet computer, wearable glasses/headset, or other device enabling display of augmented reality information.

The system generally includes commercial and residential property features that may be shown during in-person real estate showings/open houses or when renting a property, such as for a vacation rental. As employed in the system of the present invention, the AR system provides a composite view on a display that combines real world view and computer generated images and information in a single display image, where the computer generated portion of the image is overlaid upon a static or moving real-time image, typically corresponding to a user's view. Viewing device 101 is used to display the image viewed using the device's camera. Icons 102 or text 103 are shown as augmented reality elements in pre-defined spatial locations within a room being viewed, anchored spatially to remain in the same location in the space viewed as the user moves with respect to the object. This information may be partially transparent, so as to not completely obscure the underlying real-world image.

The viewer software may utilize a number of fixed buttons 104 on screen that can be selected at any time to display pre-defined non-location specific real estate or rental information, display floor plans, or toggle on/off room dimensions. The fixed buttons may be static in number or be variable in number as specified via the web portal set-up. Options for fixed button types will be available with respect to home sales (e.g. pictures, drone footage, MLS information, community information, realtor contact information, etc.) or rental (e.g. arrival information, maintenance contacts, cleaning schedules, amenities, local attractions/services, etc.) applications.

In an exemplary embodiment, as shown in FIG. 2, the invention may provide a system consisting of a commercial 3D scanning device 201 used to record spatial information 202 for a residential or commercial real estate property, which will be maintained in a local or cloud-based database 207. Web-portal software 203 enables management of meta data 204 pertaining to real estate features contained in the form of PDF files, pictures, videos, data tables, audio files text fields, 3D avatar video, or furniture libraries and enable management of that content in the database. An Augmented Reality (AR) software editor 205 will download the geometry information from the database and enable definition and placement of AR elements, including AR Shapes, AR Icons, AR Text, 3D avatars, wayfinding “breadcrumbs” and meta data links. Finally, an AR Viewer 209 will enable display of all VR visuals and linked meta data on a display device configured for this purpose. Each of these system elements may exist either as a stand-alone component or be combined with one or more other components to reduce the number of independent components of the system.

With reference to FIG. 2, the computational device of each of the AR Editor or the AR Viewer may include at least a user interface, a memory device, and a processor, and be capable of electronic communication. The processor may be a central processing unit (CPU) that manipulates data stored in the memory device by performing computations, and is configured to generate the composite AR image using the input information received from the user (location and view coordinates) along with a real world image provided, such as may be provided by a user's imaging device, for example a camera associated with the user's computer, tablet, online or mobile device; whereupon the processor processes the information received from the database that is relevant to the user's viewpoint to create the overlay of the digitally stored or accessed information upon the real world image, whereupon the composite image may then be sent to the user's display. It is contemplated that the computational device may be a portable tablet computer or mobile device having a touch screen display, through which the user interface is accessed. In the depicted embodiment, the computational device of one or both of the AR Editor and AR Viewer may access data stored in a data storage server, which may be accessible electronically, for example, via the internet and in the cloud, as is known to those skilled in the art.

In an exemplary embodiment, the system is provided with software, designated the “AR Editor” 205 in FIG. 2, that receives and processes the user's geolocation information, along with the imaging information from the 3D camera scan, whereupon the computing device will perform the necessary computations to create the AR elements that can be stored in the database and later sent to a display to create a composite image of the user's real world view. The composite image is supplemented with the relevant catalogued information, which may be in the form of overlaid AR volumes and icons on the image, the icons representing features, resources, other users, furniture, architectural features, information, video, audio, documents, images, merged into the real world image or representative image of each user's perspective. Generally, it is anticipated that the generation of the AR composite image would be similarly prepared, whether within the AR Viewer or the AR Editor, and it is primarily in the manner in which data for presentation within the display can be edited or manipulated in the AR Editor by an authorized user that distinguishes the AR Editor from the AR Viewer, as it would not typically allow rights to edit the database, other than to note or flag errors for items entered into the database. In any event, the composite view may optionally be supplemented with additional information, the contents of which may be user selectable, such as displaying date and time, an optional overlay or inset of an alternative view, current compass heading of the user's view, location coordinates of the user, communications, room dimensions, texts or software notifications, or status of equipment, such as runtime or monthly billing cost, as non-limiting examples. Where an alternate view is provided as part of the composite image on the display, it may be an inset window within the real world view image, or alternatively an overlaid image, which may be partially transparent, thus the user could view the alternate view without fully obscuring at least that part of the real world view under the overlaid alternative view. The alternate view may be user-selectable to be any of: the overhead view, typically, where the user's main image is the user's perspective view; or the user's perspective view, typically, where the user's main view is the overhead view. In another exemplary embodiment, the alternative view may selectively be another user's view or composite image. Alternative views may be access limited to enable showing different sets of AR information to different intended users (e.g. a home renter vs. a maintenance technician).

In an exemplary embodiment, the system is provided with software, designated the “Web Portal” 203 in FIG. 2, that enables management of meta data 204 including (but not limited to) PDF files, pictures, videos, data tables, audio files, text info, and furniture libraries and storage of this information in the cloud information database 207. The meta data is then in turn linked to AR objects created and defined in the AR Editor 205 for display in the AR Viewer 209.

In an exemplary embodiment of the system, each user of the AR Viewer 209 may be able to use one or more display device configured to display a relevant field of view of the user, a computing device capable of running the software and accessing the cataloged entries, and also may optionally include a camera useful for generating an image of the user's view upon which AR elements may be superimposed, as will be discussed. In an exemplary embodiment, the display device and the computing device, along with an optional camera, may be combined together, for example, the AR Viewer and or AR Editor, may utilize a tablet computer, smart phone, portable media player, laptop, or an optical head-mounted display. The AR Viewer will then display those specific entries of the cataloged information the software designates as being relevant, based on the geospatial coordinates relevant to each specific user's view, such that the appropriate information entries can be overlaid over the appropriate real world view, or static substitute image.

In an exemplary embodiment, the real world view or image in the AR Viewer is provided by a camera associated with the display system, for example, as commonly found on tablet and personal communication devices, for example, mobile phones. It is contemplated that the camera may be functionally separated from the display, and may be associated with the user, such as a body mounted camera, helmet mounted camera, a hand held camera, or an optical head-mounted display or wearable display system (e.g., smart glasses), which may be in electronic communication, such as by being connected via wired or wireless communication connection, for example, through a network connection, to a computing device for processing of the provided image information into the AR composite image which may then be displayed on a display. It is also contemplated that the camera may be a drone mounted camera wirelessly sending image information for processing into the composite AR image.

In other exemplary embodiments, the software maybe loaded onto computers, cell phones, tablets, and/or other mobile devices, such that the software is configured to communicate with a display, so as to present the composite image information to the user of the AR Viewer. The device for providing the display rendered by the software may also be a form of wearable technology capable of providing a display for the wearer, and preferably allow the wearer to see through the display. In an exemplary embodiment, the wearable technology may be an optical-head mounted display, including headsets, goggles, or AR enabled glasses. It is contemplated that the wearable technology, e.g. augmented reality glasses, may provide the required composite image, and may optionally incorporate a camera for generating the composite image, though the camera may be remote from the wearable technology, such as a user mounted camera, for example a body cam, helmet cam, an action cam (e.g., GoPro™ and the like), and the like for providing and image. For example, where the software is loaded on a mobile device having a display the software may utilize information about the user's location and view coordinates, which may then be sent to a computational device having access to the catalogued information, whereupon the computational device may select the relevant database information as determined by the software to be applicable to the location and view coordinates of the user, selected by the user, or not otherwise to be excluded by optional filters set up in the system. The computational device may be located remotely from the user, or may be contained within the user's mobile device

It is further contemplated that in an exemplary embodiment, either the person perspective view or the plan view, the AR composite image may, as an alternative to a live camera feed, may instead combine a stored image or series of images 702 relevant to the location coordinates, and optionally, the direction of view of the user, and thus corresponding to the actual location, and optionally view of the user, and not necessarily a real time view. In this manner, the AR image may be a representative image of the real time perspective, supplemented with information as provided through the system.

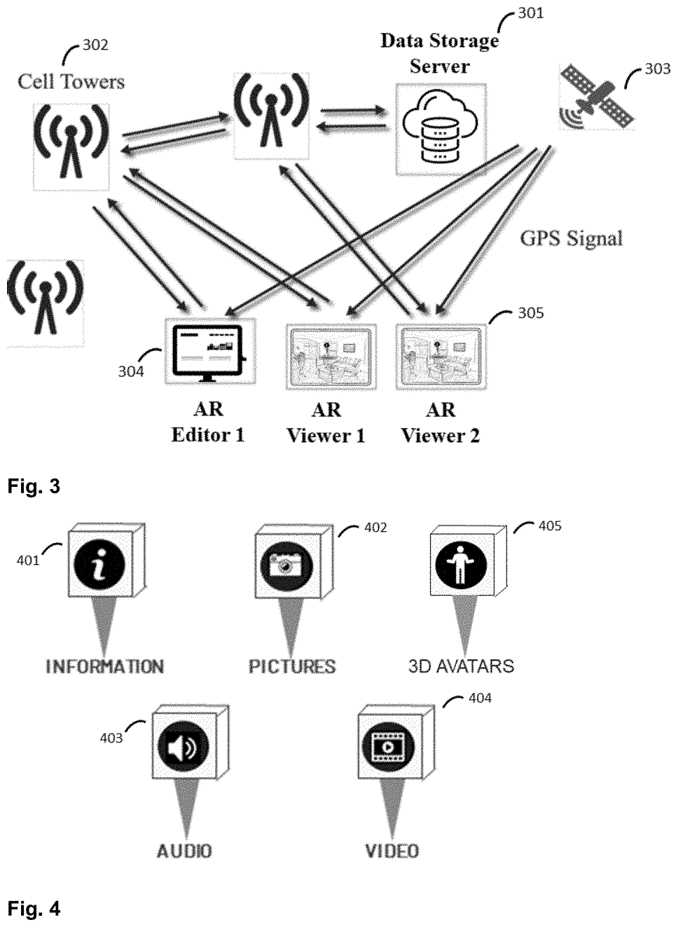

FIG. 3 shows an exemplary embodiment of the mode of communication between system components, which may include: a remote cloud-based data storage server 301 or any other suitable method or device for data storage (such as a private server or data network), a wireless communication network 302 to provide communication between devices, a global positioning system (GPS) satellite network 303 to provide geo-location information, one or more mobile devices or computers loaded with the AR Editor software 304 and capable of rendering the AR images and transmitting back to the data server for remote storage, and one or more mobile devices loaded with the AR Viewer software 305 and capable of rendering the AR image, providing location, communication, and device orientation. Electronic communication between the computational devices of the AR Editor or AR Viewer and the data storage server may be facilitated through any suitable form of electronic communication, for example, wireless communications, and as depicted in FIG. 3, may be provided through one or more cellular towers. Generally, there will be a need for the computational devices of the AR Viewer to locate and orient itself, which may be accomplished using one or more of GPS systems, cellular towers, and on board sensing devices (e.g., accelerometer, compass) to locate and provide orientation information for the devices. The location and direction of view of each specific user may be determined by using known geolocation techniques known in the art, for example, through the use of radio frequency location, LiDAR, utilizing global positioning systems (GPS) signals, cell tower transmission signal, whereby the location of each user may be determined via triangulation.

In another exemplary embodiment, it is contemplated that location and orientation information may be supplemented by the system, utilizing image information provided by the camera for the user, from which the software may identify landmarks, or the user may interact with the software, in order to identify landmarks or features within the view to positively confirm locations for the device, or placement of icons on the display. It is contemplated that landmarks or features may be recognized by artificial intelligence or may rely on user confirmation to identify features that will provide confirmation of location for the system.

In another exemplary embodiment, other known techniques for ensuring accurate geolocation may be employed, including point set registration technology, and may incorporate one or more of: 3d mapping techniques that compare the real world camera view to a prepared 3D map accessible within the system, such that relevant information for that view is contained within the 3D map, and can easily be overlaid upon the real world view; and point cloud mapping, where a camera equipped with a LIDAR or IR scanner can be utilized to create a point cloud map of the terrain and features, and can be compared to a 3D model. It is also contemplated that a point cloud map may be created in advance, and using the features from the point cloud map, the real-world view could be registered against set points within the point cloud map. By comparing the real-world view against a previously prepared map (whether 3D map or point cloud map) the accuracy of the AR composite image can be enhanced. Direction of view of each user, or the relevant camera, may be determined using known techniques, including but not limited to the use of one or more magnetic field sensors, LiDAR, and/or one or more accelerometers, to determine the directionality of the camera view, relative to the direction of gravity and magnetic north. It is also contemplated that the system may be capable of operating without a camera providing a live view.

### AR Viewer Features

The AR Viewer utilizes a combination of software and hardware, and is designed to display AR icons, volumes, pictures, 3D avatar files and text downloaded from local memory or the cloud database, superimposed upon the real world view in a composite image presented to the display. The AR Viewer may be displayed on the same, or alternatively, different display device as may be utilized with the AR Editor. In an exemplary embodiment, the AR Viewer can be utilized by more than one user, simultaneously, each displaying the AR view relevant to each user on a display dedicated to that user. It is also contemplated that a user's screen may selectively be shared with additional users. It is contemplated that AR Editor or AR Viewer users may be able to select or request access to view the composite image provided to another user of the AR viewing tool, which may be granted by the user whose display is being shared with others. It is further contemplated that the AR composite image may provide directional wayfinding guidance to the user for locating a specific AR element or specific location within a space. In such an instance, the display may include directional markers, such as finder points or directional paths that may demonstrate a path to the desired location for the user. The directional markers may be spaced apart, and be in the form of one or more waypoints that the user may be instructed to follow and pass through on the way to the desired location; or in another exemplary embodiment, the AR composite view may provide a highlighted path for the user to follow. The highlighted path and objects on the display may be updated as the user progresses towards the location, in a manner similar to that found on vehicle navigation systems, as is known to those skilled in the art.

In an exemplary embodiment, user input to the AR Viewer loaded onto a tablet computer or cell phone device may be achieved using a touch screen display where input is via a finger or stylus. In another exemplary embodiment, input to the AR Viewer loaded onto a headset/glasses may be by user gestures or movements, recognized by the software via the camera view. However, one skilled in the art should appreciate that other implements could be used for control and inputting of information, including a computer mouse, keyboard or joystick. In fact, one skilled in the art should appreciate that the computing device is a physical computer, and could be, but not limited to a desktop computer, laptop computer, tablet computer, cell phone, or wearable headset/glasses.

In an exemplary embodiment, upon opening the AR Viewer, the software may identify one or more nearby spatial features with a location point icon 102 that indicates the location of the feature in the space. In use of the system, were the user to select one or more of the icons from the display, the software would provide the general information for that property associated with that selected icon. As the user changes his field of view (e.g., by panning the camera to look in a different direction, the location point icons for nearby features would correspondingly remain fixed and anchored to the location pre-defined in the AR Editor, displayed on the composite image shown in the AR Viewer.

In an exemplary embodiment, the portion of the meta information in the database relevant to a location within or feature of a commercial or residential property may be identified by an icon indicative of the type of information available, and overlaid onto a real world image to make a composite view. FIG. 4 shows five exemplary icons envisioned to be used in the AR Viewer: information 401, pictures 402, audio 403, video 404, and 3D Avatar video 405. Additional icons/AR element types may also be used. The icons shown are conceptual in nature and may vary in final form. The icons to be displayed are to be easily recognizable by the user, so as to indicate the nature of the information represented, and may, for example, be those provided by real estate agencies and associations or as in the case of the icons shown in FIG. 4 be readily identified symbols. Unlike pictures, audio, and video, which are self-explanatory with regard to the linked meta data, the information icon may link to various formats to display the desired information, including text fields, PDF files, website links, etc.

In some embodiments, in the event that a given volume or property entry would appropriately be associated with more than one icon, it is contemplated that each of the appropriate icons may be tiled adjacent to each other in a grouping, for example in a grid pattern, that is placed above or superimposed upon the specific volume for which the icons are being depicted. In this manner, the specific icon may still be selected by the user so as to display the desired icon information, but the display may still convey to the user that additional icons (representing various forms of information) are also relevant to that volume. In such an instance, the dimensions of each icon may optionally be adjusted, either by the software or by the user, so as to avoid overcrowding of the display.

In some embodiments, the software may modify the appearance of displayed icons in order to provide depth of field, for example, in an exemplary embodiment, the icon size and transparency will adjust based on distance. In such an instance, it is contemplated that icons that are further away from the user would be proportionally smaller, and/or have decreasing opacity to the icon, when contrasted to an icon that is relatively closer to the user's location. In some embodiments, the icons may be classified by color, so as to convey information relating the grouping the icon represents, for example, icons that are representative of a video may be colored in red, icons representative of audio components may be colored in yellow. These color assignments are exemplary only and it is contemplated that other colors if any may be associated with other classifications of information. The software may allow the user to independently assign colors and characteristics to the icons as user preferences.

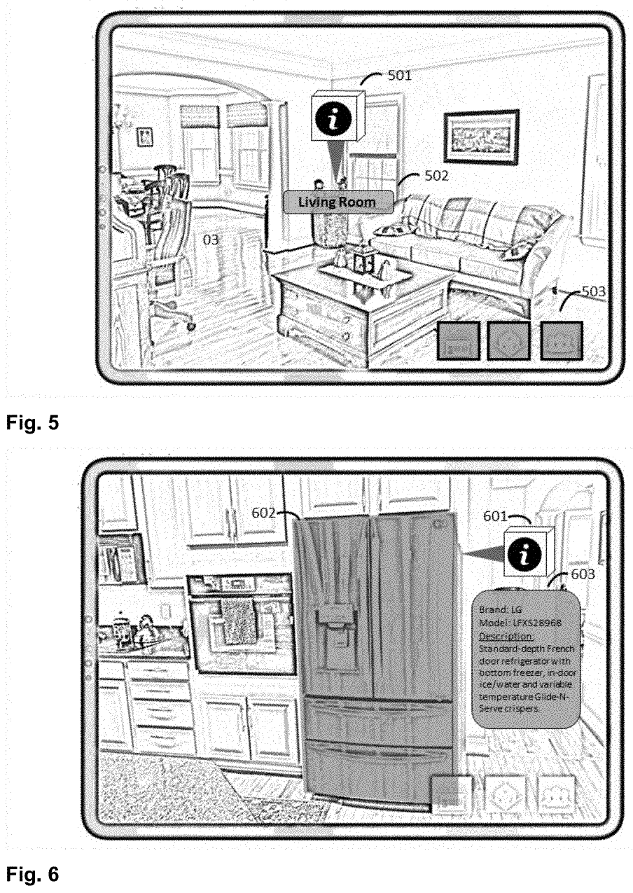

In an exemplary embodiment, FIG. 5 shows an information icon 501 indicating a feature with attached meta information, accompanied by a text field 502 identifying that the icon pertains to the “Living Room” in a residential property. The text field may be either static on screen or shown when the user selects the information icon using their finger, a stylus, or gestures appropriate for the viewer device. AR icons and shapes may also be shown without accompanying text. Icons are overlaid onto a view in a fixed location, so by adjusting the direction of view (or direction of the camera providing the view to the system), the user may readily scan the area to identify other relevant features denoted by additional icons, as the computing system overlays relevant icons onto the display for the user in the exact location defined using the AR Editor.

In an exemplary embodiments, the AR composite view sent to the user's display may provide various fixed icons, that may be in any suitable location on the display, and in FIG. 5, these are shown to the bottom right of the AR composite view. It is contemplated one or more fixed icons may appear on the display in either a static location, alternate locations depending on the space being viewed, or in a location that is user selectable, rather than being limited to the depicted locations shown in FIG. 5. The fixed icons shown may vary depending on the selection of icons from a variety of available options in the AR Web Portal. The fixed icons may only be allowed to appear when there is attached metadata for that object linked in the AR Web Portal.

In an exemplary embodiment, the directional arrow associated with an AR icon may be user selectable, enabling for example the pointer to point down 501, to the left 601, or in another direction to indicate the object to which the icon corresponds.

In an exemplary embodiment, FIG. 6 shows an informational icon 601 with the directional indicator pointed at a 3D volume 602 denoting the location of a kitchen appliance of interest, perhaps newly purchased. The object of interest, in this case an appliance, may be identified using an overlaid 3D AR shape 602. Additionally, an accompanying text field 603 may be shown that provides descriptive information on the item. For the display of the icons within the system, it is contemplated that each entry within the database would be associated with one or more icons that are associated with a location, and may also be provided with an accompanying volume entry and/or text field that is saved within the database. The system would utilize the location information for AR icons, geometric volumes, and text fields, and along with location information for the user, will create a composite image that allows the user to scan a field of view visible through though the display screen, and have the system software create a composite AR image with overlaid icons in a fixed and persistent location within the space. The intention is to provide users with an easy to use AR Viewer. The AR Viewer would identify features indicating the location and nature of the feature, and other relevant information. It is also contemplated, that where appropriate, the AR objects may be created as wire frame or partially transparent depictions, so as to minimize interference with the underlying real world image, yet still convey the necessary location information to the user. For example, the volume indicating the appliance in FIG. 6 may indicated using be a wire frame 3-dimensional prism, as an alternative to the partially transparent depiction shown 602.

In an exemplary embodiment of the composite AR image, the one or more icons may be depicted as located on the display centered above or otherwise near to the physical location the icon is to mark, rather than directly overlaid upon the volume, so as to minimize the potential of the displayed icon interfering with the user's view of the marked object on the screen, as can be seen in FIG. 6. In another exemplary embodiment, the icon would be displayed as overlying the volume on the screen.

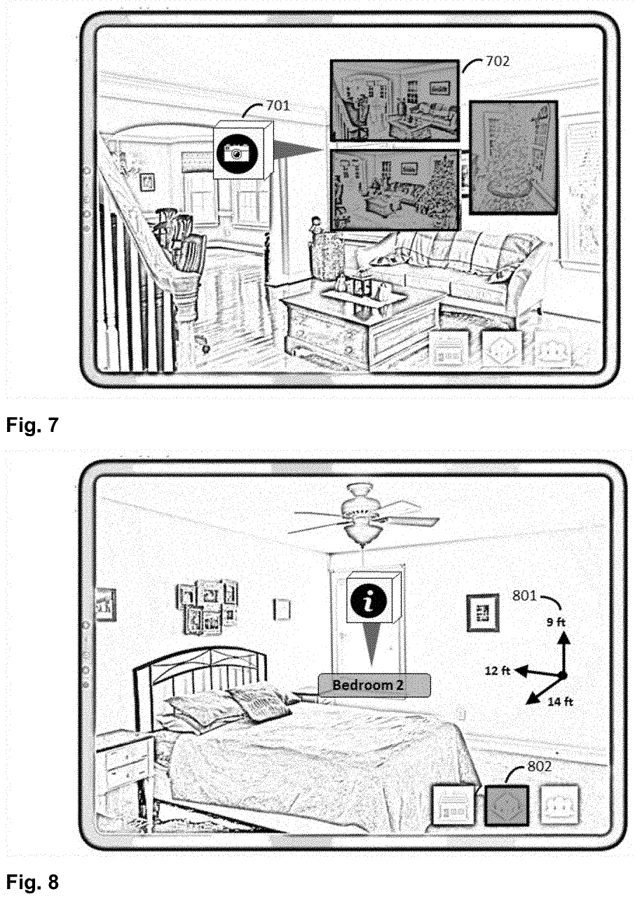

In an exemplary embodiment, FIG. 7 shows a picture icon 701 that when selected shows pictures 702 associated with the icon location. In one embodiment, the pictures may appear as small thumbnail pictures as shown 702 that when selected maximize to a full screen image. In another exemplary embodiment, a single picture may be displayed in a pop-up window with an arrow, button, or icon that allows the user to scroll through the available pictures. In yet another embodiment the pictures may be overlaid onto an AR element such as a picture “carousel” that may be manipulated in the field of view, with the picture capable of being maximized to a full screen view or minimized (i.e. returning to the carousel). The pictures shown are intended to be associated with the location and show desired information for home/retail real estate sales (e.g. in progress construction, alternate day/night,/holiday/seasonal views of the location, or special events) and rental applications (e.g. equipment operation details, feature information).

In an exemplary embodiment, FIG. 8 shows an axis icon displaying the room dimensions in x, y, and z directions. In one embodiment, the dimensions would appear in every room viewed. In another exemplary embodiment, room dimensions would be toggled on/off using one of several fixed buttons 802, in this case shown at the bottom right of the AR Viewer.

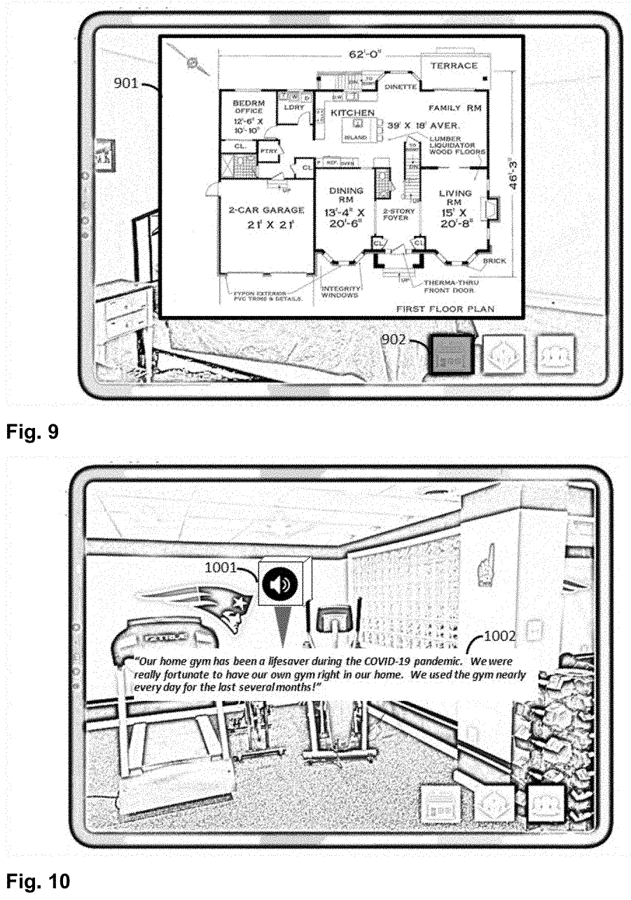

In an exemplary embodiment, FIG. 9 shows an optional 2-dimensional plan view 901 that may be selected using one of the fixed buttons 902 displayed by the AR Viewer. The plan view may be beneficial to the user to provide context for their location within the commercial or residential property and the relationship of the space they are in. The fixed button 902, upon being selected by the user, will cause the display to toggle between the previously described AR view according to the user's perspective, and a 2D plan view image of the property 901 that may be overlaid with relevant information. The image associated with the icon may shift, depending upon the screen type currently being displayed, such that while in the user's perspective mode the icon may be the satellite icon, and in the 2D plan view, the icon may be a graphic representation of the user perspective view. The 2D plan view may be any suitable overhead representation or view, including a previously generated map or static image (e.g. plan view, aerial or satellite imagery), or even an overhead live video feed, which the software may augment with relevant information. The plan view would be similar to mapping functions known in the art, where the user's location may be identified on the map, and relevant icons overlaid upon the 2D plan view image to represent relevant volume information in the vicinity of the user, or selected points. The scale of the displayed image may be user selectable, either by inputting a scale, sliding or swiping a scale, using buttons or selectable icons for +/−, or using a gesture, as may be known in the art to vary the scale selection. For example, the scale of the display may be user adjustable by pinching or expanding two fingers placed against the touch screen. Additionally, the map center location may be moved by dragging with a stylus or finger to relocate the center of the map, or alternatively selecting a new point for the processor to prepare a composite image centered on the selected point.

In an exemplary embodiment, FIG. 10 shows an audio icon 1001 that may be used to play an audio message 1002 that communicates a detail about the space being viewed or a feature within that space.

In an exemplary embodiment, FIG. 11 shows a video icon 1101 that when selected displays a text field 1102 and a video file 1103. The video may also play without a corresponding text field.. The video may be shown either in a pop-up window, at a fixed point in the AR view in a pre-defined and fixed spatial location, or be maximized to a full-screen view. The video may be accessed from a stored video file from memory or the system's cloud database, or be displayed from a web pop-up from a common video platform such as YouTube™. In one embodiment, the video may display as a standard pop-up video in a fixed location on the screen with a fixed aspect ratio, or maximized to full screen. In another exemplary embodiment, the video may be anchored to a fixed plane within the 3D view so that it may appear within a “picture frame” on a wall and the aspect ratio of the video will change as the user moves to a different location within the room or changes the orientation of the AR Viewer.

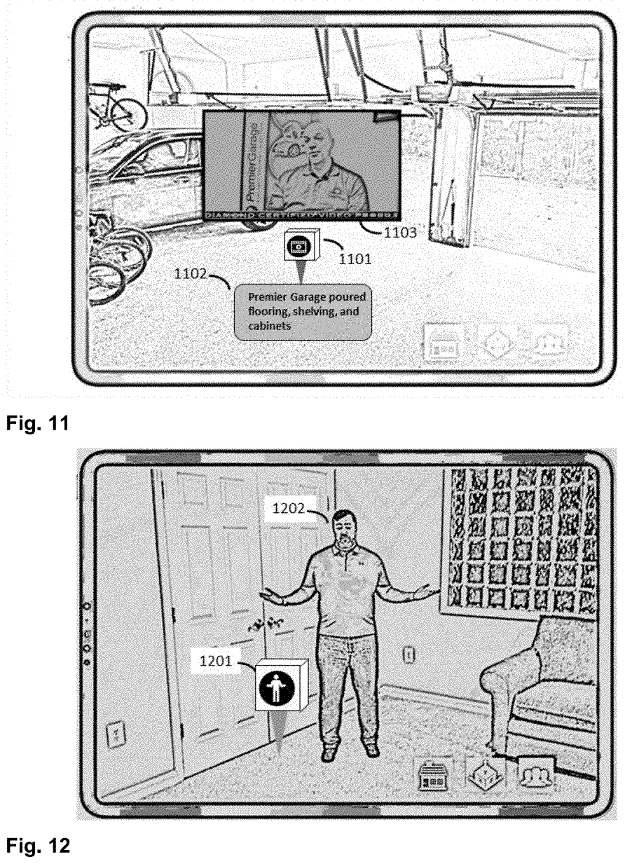

In an exemplary embodiment, FIG. 12 shows a depiction of the display of a 3D Avatar augmented reality element 1202 associated with its corresponding icon 1201. The 3D Avatar is a 3D video motion capture data file obtained from a scanning device specifically designed to record video data of a person/objects in 3D, as is known in the art. The 3D Avatar may appear on screen in a fixed location or may appear when its associated icon 1201 is selected. The 3D Avatar will remain in a fixed location and face in a fixed direction within the space, enabling the user to travel around to view the avatar from all directions (front/back/side) as the user moves with respect to the 3D Avatar. The 3D Avatar video may or may not include accompanying sound imbedded in the native data file.

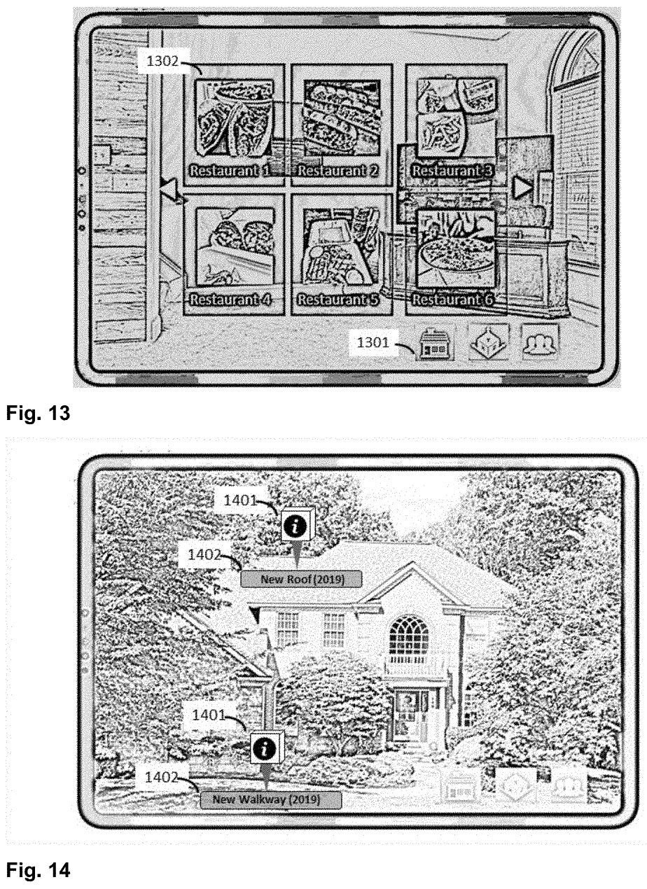

In an exemplary embodiment, FIG. 13 shows an example of depiction of the display of AR information that is not oriented in a fixed location within the space but rather is located at a fixed distance away from the viewer within the space, displayed as an AR element. AR information not oriented in a fixed location (designated by an AR icon) will instead be accessed via one of the on-screen buttons 1301 linked via the AR Web Portal. Tiled AR information 1302 may be used to show information not within the space being viewed but pertinent to that space, such as identifying nearby attractions, restaurants, grocery stores, or other amenities searchable by the user. In another exemplary embodiment, this information may be shown in other AR formats other than the six tile arrangement in FIG. 13, such as in a carousel arrangement.

In an exemplary embodiment, FIG. 14 shows a depiction of the display of AR information, icons 1401 and text fields 1402 associated with the invention included in a composite view of an exterior rendering of a residential property. In one embodiment, the composite image may be formed by combining the AR elements and a live image obtained from the AR Viewer's camera. In another exemplary embodiment, the composite may be formed by displaying the AR elements superimposed on a picture file.

In some embodiments of the AR Viewer, there may be an edit button would be located on the display, such as in the bottom right corner. Selection of the edit button would toggle the system to enter an edit mode within the AR Editor. In the edit mode, a user having appropriate editing privileges may then update, modify, add or delete information from the database. The edits made may then be reflected in the information displayed to all users of the AR Viewer.

In some embodiments of the system, a user may utilize an edit function to update meta information information in real time, or may make edits to the database information that is updated as a batch. It is contemplated that the user edits may be made regardless of the user's location, for example, where the user is on property assessing the features, for example; or alternatively, the user may be remotely located and making edits to the information away from the site being assessed, relying on notes, or images taken of the location.

Where the AR Editor must ensure integrity of the records within the database, whether by allowing only a single editor at any given time, or ensuring that multiple concurrent users do not create conflicting entries by editing the same volume information, the AR Viewer, by contrast, may readily accommodate one or more concurrent users, as the viewers are not revising the entries within the database, and are only displaying relevant records. In an exemplary embodiment, it is contemplated that each of the AR Viewer users may utilize information specific to each user's location and view, as made known to a computing device, whereupon the computing device may overlay at least a portion of the relevant information onto an image representative of the specific user's view and/or location, and presented on each user's display as an AR composite view.

### AR Editor Features

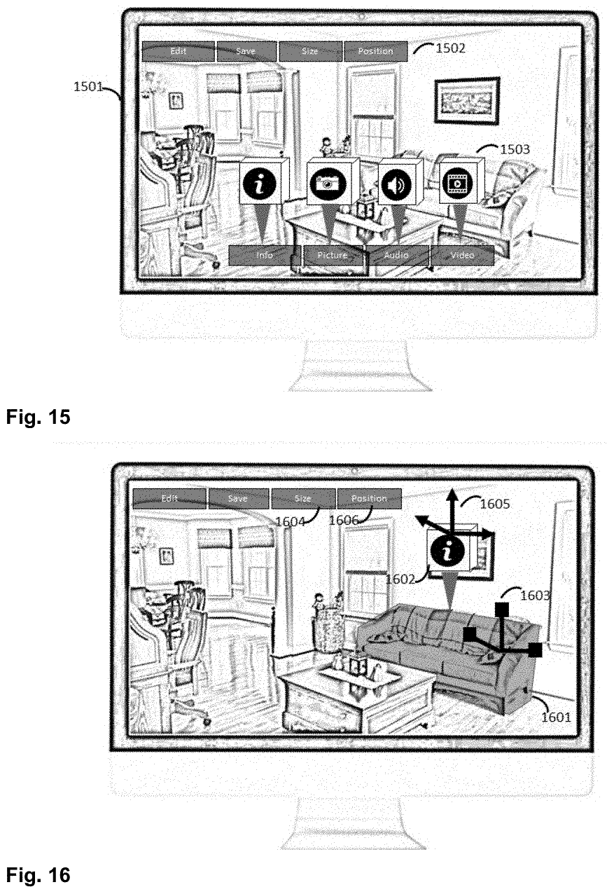

In an exemplary embodiment, the AR Editor software is the part of a system that is used to define the location of AR elements (icons, 3D volumes, 3D avatars and text with the necessary hardware, including a computing device and a display device. The computing device includes a user interface and a central processing unit. The AR Editor's display device may be, for example, a mobile or fixed touchscreen display, such as a computer tablet or laptop display, a handheld cell phone display, portable media player, or a desktop computer display. The AR software editor is typically accessed via a graphical user interface (GUI), that will allow the user to input the location of AR icons, 3D volumes, text and other objects representing the features and points of interest within the 3D scanned representation of the associated space. The defined AR elements may then be cataloged and stored in memory (remotely or locally on the system) that is accessible by the software. The AR icon may be linked to meta information associated with the indicated location using the AR Web Portal. A representative image of a display from the AR Editor, depicting the icon selection step is depicted in FIG. 15. The AR Editor is located on a desktop computer 1501 in this figure. FIG. 15 shows the AR Editor's fixed menu buttons 1502 and four icons 1503 that may be selected among others to indicate the nature of the linked meta data. The user may choose to define an icon, 3D shape, and/or text box at any defined location. While the user may select an appropriate icon to associate with a volume in the displayed view, the user may alternatively select any of the fixed system icons on the periphery of the display, so as to navigate within the software. Other system navigation buttons that may be selected within either the AR Editor include icons for “Home” “Dimensions” “Community” “Help”, “Map View”, “AR view”, “Info”, and “Main Menu”, as non-limiting examples in the location shown 1302 or alternate location.

In an exemplary embodiment, the AR Editor allows someone using the software to edit the properties of an AR element (e.g. size, location), which thereby updates the associated database meta information, which may be stored in computer accessible memory, in any suitable form. The memory storage may be achieved through the use of a storage device having computer components and recording media used to retain digital data, such that information stored therein is electronically accessible. The information stored in memory may be selectively edited or otherwise modified by an AR Editor user.

In using the AR Editor, a user may view the 3D geometry on the display, and interact with the software via the user interface, which may be through any suitable input mechanism, such as entering inputs through gestures and entries made to touchscreens of the display. A user may make edits to record or modify an entry within the database, by initially selecting an edit icon, which, if the user is onsite, or nearby to the site of the location of the entry to be edited, the software will display a selectable edit icon visible to the user, which may be located on the home screen of each icons informational window. The edit function may also be used while the user is remotely located. In either event, the user may select to edit one or more of the entries in the database.

Within the AR Editor, the user may select “add volume” whereupon the software may provide visible on the displayed image a generic geometric shape (such as a cylinder, sphere or a rectangular prism) or other 3D volume such as a 3D real estate related element or 3D furniture item, which the user may then manipulate through the interface in order to adjust the dimensions and location of the cylinder to encompass the feature for which the volume is being defined. The 3D volume may be depicted transparently, overlaid onto the associated feature in the composite image that is being demarcated. This is illustrated in FIG. 16, where a living room couch is highlighted as a feature of interest using a rectangular prism 1601 having the approximate dimensions of the couch.

Once the volume for that entry is established, the user may be prompted to associate the entry with one or more relevant icons. The icons as described may be those defined by standards or associations, representative examples can be seen with reference to FIG. 4. The user may be presented with a list, whereby the user may scroll through the icons, selecting those that apply. It is contemplated that in selecting the relevant icons, rather than scroll through the list of icons, the user may instead type a full or partial name of each icon in a search box, where the software will provide a listing of possible icons to select from that correspond to the entered text information; or alternatively, the user may select filters that may be applied over the listing, thereby narrowing the selections available based on the filter results, in order to allow efficient icon selection. For each icon selected by the user to associate with an entry, the software may present a window or text box on the display, in which the user may enter information that may be associated with each icon for that entry in the database. FIG. 16 shows an information icon 1602 associated with a defined 3D shape 1601.

In an exemplary embodiment, the adjustment of the size of an icon or 3D object may rely on using buttons to modify the length, width, and height of the volume defined. In another exemplary embodiment, the user may use lengthen and shorten the outlined edges of the prism through the touch screen interface by manipulating an axis 1603 provided for this purpose. In this embodiment, the resizing axis appears upon selecting the “size” button 1604 from the AR Editor menu.

In an exemplary embodiment, the position of an icon or 3D object may be modified using buttons to modify the position of the object in the x, y, or z directions. In another exemplary embodiment, the user may reposition the object by manipulating an axis 1605 provided for that purpose. In this embodiment, the repositioning axis appears upon selecting the “position” button 1606 from the AR Editor menu. As the AR composite image displays the prism overlaid over the camera view, the user can guide the prism to visibly encompass the feature within the volume of the prism, which may then preserve the boundary information, and create the volume to be saved for the relevant entry. After the feature volume is defined and anchored to a point the user may be prompted to provide additional information requested by the software, as will be discussed.

In some embodiments of the AR Editor and AR Viewer, there will be the ability to edit and customize how AR is displayed in size, color, transparency, font size as non-limiting examples.

Within the AR Editor, the user may select informational icons to associate with one or more text field entries in the database. This information would be displayed AR text field in the AR Viewer when an icon is selected. For example, for each icon, there may be at a minimum an object name and description text box. When a user selects the icon, the software will display the information box, which may be of any suitable size to display the text, but be no greater than the screen size, and may have scrolling function to display lengthy text information, and further may be provided with a close button to allow the window to be selectively closed. Where an icon does not have information to be displayed, for example, where an editor has not filled in the information, in such an instance the information window may not appear on a viewer, thereby serving the number of items displayed on screen. For example, if the object name is filled out but not a description, only the text field associated with the object name would appear in the AR Viewer.

In an exemplary embodiment, once an icon or 3-dimensional volume is defined, specific additional meta data from the database would be specified and linked to that icon or volume in the AR Web Portal such that when an icon or volume is selected by user input in the AR Viewer the additional information is accessed. One or more items from the available meta data within the database may be selected and linked to an icon or volume. Once the linked information is selected, the method for displaying that information within the AR Viewer will also be specified from among various choices, including, but not limited to: pop-up windows within the viewer, full screen display, on-screen thumbnail pictures, or specialized informational windows or symbols.

In an exemplary embodiment, the AR Editor may be used to add a 3-Dimensional AR object representative of a furniture object within a space. One or more furniture objects may be defined in a room to “virtually stage” that room. This is particularly useful for properties that are being put on the market unfurnished. AR furniture objects may be selected from one or more libraries within the database associated with specific furniture manufacturers that provide information for use by the system. In an exemplary embodiment, the AR Editor may be used to provide a method of showing specific information for that furniture item to the user of the AR Viewer, such as a project identification number, should the user of the AR Viewer be interested in purchasing this item at a later time.

In an exemplary embodiment, the AR Editor may be used to define representative wall or floor coverings within a space as graphic files defined over a specific area in a plane in the 3D representation of a commercial or residential property. For example, a graphic depicting an oak colored wood floor may be defined at the plane of the existing floor so that this alternate floor covering could be displayed in the AR Viewer.

In some embodiments the AR can be customized based on user generated profiles. The AR views for each individual user would reflect and be based on a profile to show users their desired features in AR. As a non-limiting example one user may be shown wood floors, a specific paint color on the wall, or furniture or decorating style they desire, while a second user is seeing an alternative floor (tile), different paint color, furniture and decorating style in the same space.

In an exemplary embodiment, the AR Editor may also be capable providing a reminder for those icons that require updating periodically. The software will allow for the creation of a reminder associated with each icon that will allow the user to specify a date and reoccurring time frame to trigger a reminder message. For example, the software may periodically generate a message via email of necessary updating. For example, the user may specify a date of and then specify weekly interval for reminders. The software would then be capable of alerting the user on the required periodic interval, such as reminding the user on a weekly basis. The time frames for periodic reminders may be any of hourly, daily, weekly, monthly, quarterly, semi-annually, and annually. In an exemplary embodiment, a text box will be available for a short message describing the reminder and then generate a message, such as an email, where the reminder will be sent to the specified user. Additionally, for a selected volume, time period, or geographic locale, it is contemplated that the system may generate a report that may be useful for determining any updates that may be required within the given parameters. Such a report may be generated periodically by the system, or upon initiation by a user.

In an exemplary embodiment, access and/or editing privileges may be restricted to previously identified, or otherwise authenticated users, relying on verification of authority to add new, delete, or edit the information stored in the system. For example, appropriate users may be designated, and have to satisfy password protection requirements, or otherwise be verified as having editing privileges, using techniques and methods known to those skilled in the art.

It is contemplated that, in an exemplary embodiment of the AR Editor, there may be multiple users that would have editing privileges and needing to access the catalogued information. In such an instance, the system may employ strategies to prevent incompatibilities in the information that can arise from having more than one editor from making changes at a time. For example, the system may lock out additional editors from making changes when another editor is already accessing and editing the catalogued information, in a manner as is known where the user is to digitally check out the document for edits, and the software is configured to prevent others from editing until the document is checked back in as available. Alternatively, the system may utilize known collaborative editing solutions to prevent conflicting edits from being made simultaneously by multiple editing users, such as locking a specific category of information, such as site-specific information, when a first user is editing the specific category or site information. In this manner, a second user is prevented from editing the same category or property simultaneously, to avoid conflicting entries, though the second user would not be prevented from editing a different category or property simultaneously. In any of the embodiments, it is contemplated that the system may track edits by user, by the modification made, the date and time stamp of the modification, and which hardware was utilized in making the edit. In this manner, the system could ensure that edits are capable of being reviewed as part of a quality control confirmation and improper or unnecessary edits may be selectively removed, if so desired or necessary.

### Database Features

In an exemplary embodiment of the system according to the invention, there is provided Web Portal software, FIG. 2 203 that is designed to accept meta information, for linking to AR objects using the AR Editor for display by the AR Viewer. The Web Portal software will catalog the meta data information for storage in memory in its native form (PDF files, picture files, audio files, spreadsheet files, etc.) and be accessible by the software and the computing device. Such a database may be stored remotely in a cloud based data storage server, FIG. 2—207, and the database may consist of a record for each entry, and may provide a unique record identification number; information regarding the item title, class or type; a text description of the item; video, digital document, embedded software application, deep linking, and may include any other further information such as the date issued or entered into the database, whether the item is active or inactive, and any notes or reminders to re-assess the information on a periodic basis. It is also contemplated that the Web Portal software would allow for the entry of meta data information, such as PDF, word, audio file, video file, or image documents associated with an entry in the database, such that relevant documentary information may be easily accessed through the system. The nature of the information that is to be stored in the database may vary based on the nature of the subject item, and would be well understood by those skilled in the art. In the following description, for the purposes of explanation, numerous specific details are set forth in order to provide a thorough understanding of the present invention. It will be evident, however, to one skilled in the art that the present invention may be practiced without these specific details.

In some embodiments of the system, when the AR Web Portal is accessed, the software would be prompted to provide a list of options for the user to select, including “saved properties”, “search”, or “add new property” option on the user interface or display. If “add new property” is selected, the user is to be asked to enter the property location and volume encompassing the total property. Selection of “saved” properties would allow the editing user to browse the entries of properties within the database. Selection of “search” feature would allow the user to enter a search keyword or additional limitations, such as class of entry or location reference for entries within the database.

The database's memory device may be a storage device having computer components and recording media used to retain digital data. The memory device may be remotely accessed, such as through a data storage server, or remote computer, or may even be stored locally in one or more users' computational device. In an exemplary embodiment, the computational device may be the tablet or smart phone, and is to be carried by the user, and may have a copy of the database, which may be complete or partially complete of the information, locally stored in the memory accessible by the computational device. The database may be updated wirelessly, or the computational device may be placed into a network connection with another computer or server, whereupon any updates to the database information may be received through the network connection, whether wireless or wired whereupon the most up-to-date information may be reflected in the locally stored copy of the information. Alternatively, the computational device may wirelessly access a remotely stored database, which may itself be periodically updated to include the most up-to-date information, reflective of any edits made by the editing user(s).

It is contemplated that updates to the database, if they interfere with the use of the AR Viewer, or AR Editor, may be inopportune when a user is actively using the system and accessing individual linked files. To avoid the possibility of an update impeding with a user's access to the system, it is contemplated that when there is an update pending, the system may trigger a notice to the user, such as an email, text notice, or provide a visible icon on the display, at a time and/or at a location on the display where the icon would not interfere with normal use of the device. In such an instance, the user may select when or opt to activate the update at a time and place that is convenient for that user, so as to ensure that there are no detrimental effects from performing the update at an inopportune time.

When completed the information is saved to the database on the data storage server, the revised information may then be made available to the linked AR Viewers. Within the AR Editor and AR Web Portal, further revisions to each property can be made by the editing user selecting the edit button, and searching for, or selecting the pre-existing property from the menu, using a similar process as has just been described.

In some embodiments, the information entered by the editing user into the database may then be saved, and the revised contents of the database may then be made available to the linked AR Viewers. The revised database may be stored within the electronic memory of an editor computation device, which may then be accessed as needed by various AR Viewers. Alternatively, the revised database may be proactively distributed or pushed electronically, such as network or wireless signal, to the computation devices of various AR Viewers, and stored locally on the computation device utilized by each AR Viewer. In another exemplary embodiment, the media containing the revised database may be distributed to each AR Viewer, such as on a digital storage medium, such as thumb drive, flash card, or the like, and loaded into the computation device(s) utilized by each of the AR Viewers.

Should additional edits be necessary, the editor user may further edit the property information as needed, using the edit button and searching or selecting the pre-existing property from the menu. The revised information may then be distributed as discussed above. General Comments

The foregoing paragraphs illustrate some of the possibilities for practicing the invention. Many other embodiments and fields of use for a system for preparing an augmented reality display and hazards and resources database, and the components thereof contributing to the invention are possible and within the scope and spirit of the invention. It is, therefore intended that the foregoing description be regarded as illustrative rather than limiting, and that the scope of the invention is given by the appended claims, together with their full range of equivalents.

The present disclosure is to be considered as an exemplification of the invention and is not intended to limit the invention to the specific embodiments illustrated by the figures or description above.

What is claimed is:

1. An augmented reality display system for real estate information features, the augmented reality display system comprising:
an augmented reality editor and an augmented reality viewer, the augmented reality editor configured to allow editing and entry of volume information concerning at least one of commercial and residential properties, for access by the augmented reality viewer configured to generate an augmented reality composite image; the augmented reality editor includes:
an editor display device,
electronic memory storage,
a computer accessible database containing volume information identifying property features and stored in the electronic memory, and
a computational device and editing software configured to allow entry and selective modifications to the volume information; and,
wherein the augmented reality tool viewer includes:
a viewer display device,
a user interface,
a camera, and
a computing device and viewing software configured to electronically access the computer accessible database and create a composite image for viewing on a display, the composite image comprising volume information overlaid upon an image.

2. The augmented reality system of claim 1, wherein the image is one of: perspective view received from the camera, or 2D plan view.

3. The augmented reality system of claim 2, wherein the composite image includes an image received from the camera, and the overlaid volume information includes metadata relating to real estate features and provides at least one of text, volumetric shapes, icons, pictures, graphics, or 3D avatars.

4. The augmented reality system of claim 3, wherein the composite image provides overlaid volume information anchored spatially to remain in the same location in the space depicted within the image, as the camera is moved with respect to the volume location.

5. The augmented reality system of claim 4, wherein volume information provided in the composite image is preserved by the editing software as a fixed persistent location in the space of the image.

6. The augmented reality system of claim 1, wherein the viewer display device is a touch screen for use with a finger or stylus and configured to recognize inputs and gestures.

7. The augmented reality system of claim 6, wherein the input and gestures are configured to allow navigation through the user interface.

8. The augmented reality system of claim 4, wherein the composite image displays an icon representative the volume information within the composite image, and is provided as one of a wire-frame or partially transparent depiction.

9. The augmented reality system of claim 8, wherein the icon graphically represents the nature of the volume.

10. The augmented reality system of claim 9, wherein the icon has metadata including a plurality of pictures, wherein the plurality of pictures are overlaid on the image as a picture carousel and having a selected picture that is larger than the other pictures of the carousel.

11. The augmented reality system of claim 10, wherein the pictures of the picture carousel provide alternative views of the volume.

12. The augmented reality system of claim 9, wherein the icon displayed on the composite image varies in a property proportional with the distance from the camera.

13. The augmented reality system of claim 12, wherein the property is selected from the group of size, opacity, and combinations thereof.

14. A method of using an augmented reality system for real estate information, the augmented reality system configured to provide a composite augmented reality image comprising volume information and an image, the method comprising:
providing an augmented reality editor and an augmented reality viewer;
providing an electronically accessible database containing volume information concerning at least one of commercial and residential properties stored in an electronic memory;
providing image representative of a user perspective;
determining volume information from the electronically accessible database correspondingly located within the image,
overlaying an icon representative of each volume information onto the image to provide a composite augmented reality image; and
providing the composite augmented reality image on a user display.

15. The method of claim 14, wherein the image is one of: perspective view received from the camera, and a 2D plan view.

16. The method of claim 15, wherein the composite augmented reality image includes an image received from the camera, and the overlaid volume information includes metadata relating to real estate features and provides at least one of text, volumetric shapes, icons, pictures, graphics, or 3D avatars.

17. The method of claim 16, wherein the composite augmented reality image provides overlaid volume information anchored spatially to remain in the same location in the space depicted within the image, as the camera is moved with respect to the volume location.

18. The method of claim 17, wherein volume information provided in the composite image is preserved by the editing software as a fixed persistent location in the space of the image.

18. The method of claim 14, wherein the user display is a touch screen for use with a finger or stylus and configured to recognize inputs and gestures.

19. The method of claim 18, wherein the input and gestures are configured to allow navigation through the user interface.

20. The method of claim 17, wherein the composite augmented reality image displays an icon representative the volume information within the composite augmented reality image, and is provided as one of a wire-frame or partially transparent depiction.

21. The method of claim 20, wherein the icon has metadata including a plurality of pictures, wherein the plurality of pictures are overlaid on the image as a picture carousel and having a selected picture that is larger than the other pictures of the carousel.
